(19) United States
(12) Patent Application Publication
(10) Pub. No.: US 2009/0002996 A1
(43) Pub. Date: Jan. 1, 2009

(54) Heat-dissipating device for an LED

(75) Inventor: Shen-Yuan Wu, Sinjhuang City (TW)

Correspondence Address: JACKSON WALKER, L.L.P., 112 E. PECAN, SUITE 2400, SAN ANTONIO, TX, 78205, US

(73) Assignee: Keeper Technology Co., Ltd.

(21) Appl. No.: 11/823,696

(22) Filed: Jun. 28, 2007

(51) Int. Cl. F21V 29/00

(52) U.S. Cl. 362/294

(57) ABSTRACT

A heat-dissipating device has a circuit board, two layers of heat-dissipating paste and a heat-dissipating metal block. The circuit board has a light emitting diode mounting segment, multiple through holes, multiple metal rods and multiple electrical nodes. The through holes are defined through the circuit board and are arranged in the light emitting diode mounting segment. The metal rods are mounted respectively in the through holes. The electrical nodes are mounted on the top around the light emitting diode mounting segment. The first layer of heat-dissipating paste is coated on the light emitting diode mounting segment and contacts with the metal rods in the through holes. The heat-dissipating metal block is attached to the bottom of the circuit board. The second layer of heat-dissipating device is mounted between the circuit board and the metal block and contacts with the metal rods.

### BACKGROUND OF THE INVENTION

1. Field of the Invention

The present invention relates to a heat-dissipating device, and more particularly to a heat-dissipating device for a light emitting diode (LED) and that is easily manufactured with a lowered cost.

2. Description of Related Art

Light emitting diodes (LED) are widely used due to lower heat generation, low power consumption, high power efficiency and small volume. However, the conventional light emitting diodes still generate a lot of heat after a long time of use, such that a heat-dissipating device is always necessary for the light emitting diodes.

With reference to FIGS. 3 and 4, a conventional heat-dissipating device for an LED comprises an aluminum substance (30), an insulation layer (31), two layers of heat-dissipating pastes (33,35) and an aluminum heat-dissipating block (34). The substance (30) has two electrical nodes (32). The insulation layer (31) is attached to the top of the substance (30), and an LED chip (40) is attached to the insulation layer (31). The LED (40) has two legs (41) connected respectively to the nodes (32) on the substance (30). One layer of heat-dissipating paste (33) is mounted between the insulation layer (31) and the LED chip (40), and the other layer of heat-dissipating paste (35) is mounted on the bottom of the substance (30). The heat-dissipating block (34) is attached to the bottom of the substance (30) and contacts with the layer of heat-dissipating paste (35).

Accordingly, the heat generated during the operation of the LED chip (40) will be transmitted to the heat-dissipating block (34) through the layers of heat-dissipating pastes (33,35), the insulation layer (31) and the substance (30) and is dissipated.

However, the aluminum is expensive, so the cost for manufacturing the convention heat-dissipating device is high. In addition, the aluminum substance (30) has a circuit formed on the substance (30), so the insulation layer (31) is necessary for separating the LED chip (40) and the circuit on the substance (30). Therefore, the structure of the conventional heat-dissipating device is complicated.

To overcome the shortcomings, the present invention tends to provide a heat-dissipating device to mitigate or obviate the aforementioned problems.

### SUMMARY OF THE INVENTION

The main objective of the invention is to provide a heat-dissipating device for an LED and that has a simplified structure and is easily manufactured with a lowered cost. The heat-dissipating device has a circuit board, two layers of heat-dissipating paste and a heat-dissipating metal block. The circuit board has a light emitting diode mounting segment, multiple through holes, multiple metal rods and multiple electrical nodes. The light emitting diode mounting segment is defined in the top of the circuit board. The through holes are defined through the circuit board and are arranged in the light emitting diode mounting segment. The metal rods are mounted respectively in the through holes in the light emitting diode mounting segment. The electrical nodes are mounted on the top around the light emitting diode mounting segment. The first layer of heat-dissipating paste is coated on the light emitting diode mounting segment and contacts with the metal rods in the through holes. The heat-dissipating metal block is attached to the bottom of the circuit board. The second layer of heat-dissipating device is mounted between the circuit board and the metal block and contacts with the metal rods.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional side view of an LED chip with a heat-dissipating device in accordance with the present invention;

FIG. 2 is a top view of the circuit board of the heat-dissipating device in FIG. 1;

FIG. 3 is a cross sectional side view of an LED chip with a conventional heat-dissipating device in accordance with the prior art; and

FIG. 4 is a top view of the substance of the conventional heat-dissipating device in FIG. 3.

### DETAILED DESCRIPTION OF PREFERRED EMBODIMENT

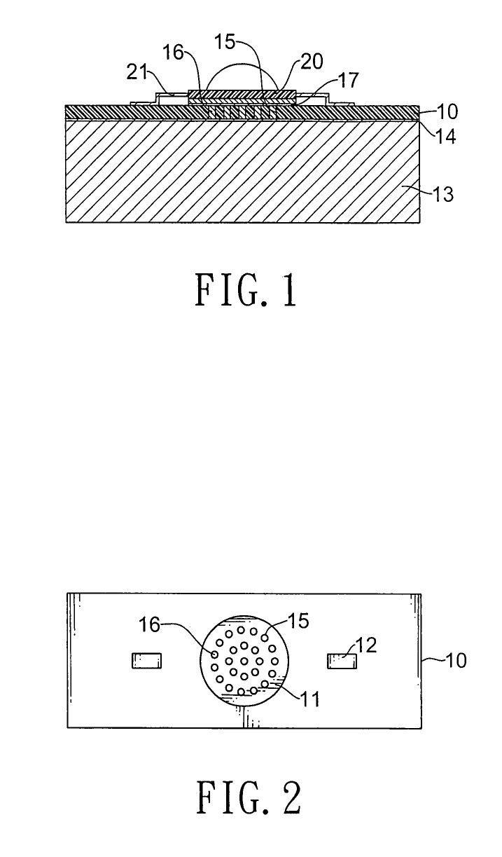

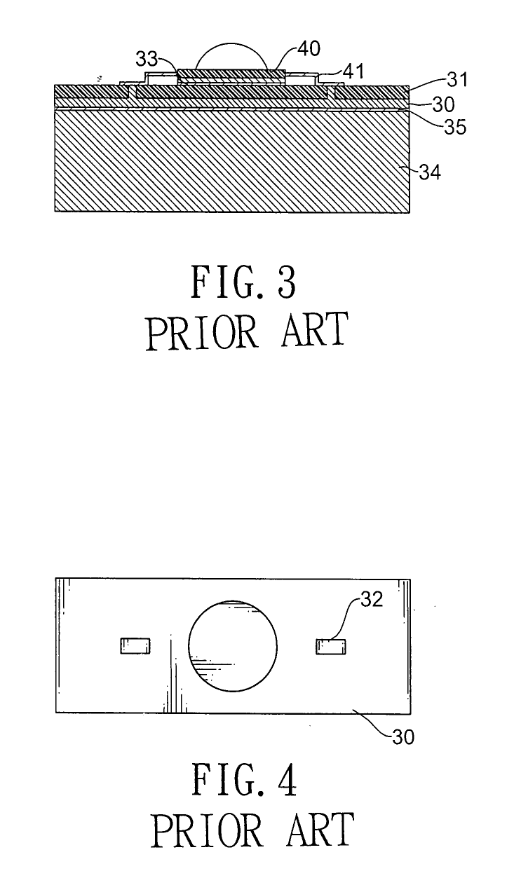

With reference to FIGS. 1 and 2, a heat-dissipating device for a light emitting diode comprises a circuit board (10), a first layer of heat-dissipating paste (17), a second layer of heat-dissipating paste (14) and a heat-dissipating metal block (13). The circuit board (10) has a light emitting diode mounting segment (11), multiple through holes (15), multiple metal rods (16) and multiple electrical nodes (12). The light emitting diode mounting segment (11) is defined in the top of the circuit board (10), and an LED chip (20) is mounted on the light emitting diode mounting segment (11). The through holes (15) are defined through the circuit board (10) and are arranged in the light emitting diode mounting segment (11). The metal rods (16) are mounted respectively in the through holes (15) in the light emitting diode mounting segment (11). In a preferred embodiment, the metal rods (16) are made of zinc. The electrical nodes (12) are mounted on the top around the light emitting diode mounting segment (11) and are connected to legs (21) of the LED chip (20).

The first layer of heat-dissipating paste (17) is coated on the light emitting diode mounting segment (11) and contacts with the metal rods (16) in the through holes (15). The heat-dissipating metal block (13) is attached to the bottom of the circuit board (14). The second layer of heat-dissipating paste (14) is mounted between the circuit board (10) and the metal block (13) and contacts with the metal rods (16).

With such a heat-dissipating device, the heat generated during the operation of the LED chip (20) can be efficiently transmitted to the heat-dissipating metal block (13) through the heat-dissipating pastes (14,17) and metal rods (16) and is dissipated. With the arrangement of the circuit board (10), circuit is directly formed on the circuit board (10) and an insulation layer as the conventional one is unnecessary. Additionally, the cost for the circuit board (10) is cheaper than that for an aluminum substance with circuit on as the conventional one. Therefore, the heat-dissipating device in accordance with the present invention has a simplified structure, and the cost for manufacturing the heat-dissipating device is lowered.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat-dissipating device for a light emitting diode comprising:
a circuit board having
a top;
a bottom;
a light emitting diode mounting segment defined in the top;
multiple through holes defined through the circuit board and arranged in the light emitting diode mounting segment;
multiple metal rods mounted respectively in the through holes in the light emitting diode mounting segment; and
multiple electrical nodes mounted on the top around the light emitting diode mounting segment;
a first layer of heat-dissipating paste coated on the light emitting diode mounting segment and contacting with the metal rods in the through holes; and
a heat-dissipating metal block attached to the bottom of the circuit board; and
a second layer of heat-dissipating paste mounted between the circuit board and the heat-dissipating metal block and contacting with the metal rods.

2. The heat-dissipating device as claimed in claim 1, wherein the metal rods are made of zinc.
